(19) United States
(12) Patent Application Publication
(10) Pub. No.: US 2019/0297918 A1
(43) Pub. Date: Oct. 3, 2019

(54) METHOD FOR PRODUCING AN ANIMAL FEED PRODUCT

(71) Applicant: TIERNAHRUNG DEUERER GMBH, Bretten (DE)

(72) Inventors: Hans-Juergen DEUERER, Bretten (DE); Goetz KUEBLER, Bretten (DE)

(21) Appl. No.: 16/302,847

(22) PCT Filed: May 24, 2017
(86) PCT No.: PCT/EP2017/062503

§ 371 Date: Nov. 19, 2018

(30) Foreign Application Priority Data
May 25, 2016 (DE) 10 2016 109 669.5

(51) Int. Cl. A23K 50/40; A23K 20/10; A23K 40/30

(52) U.S. Cl. CPC A23K 50/40; A23K 40/20; A23K 40/30; A23K 20/10

(57) ABSTRACT

The invention relates to a method for producing an animal feed product. According to a further aspect of the invention, an animal feed product is provided. The claimed method and the claimed animal feed products are characterised in that the corresponding product is customised.

The invention relates to a method for producing an animal food product.

In a further aspect, in accordance with the invention an animal food product is provided. The method of the invention and the animal food products of the invention are distinguished by an individualization of the product in question.

### PRIOR ART

A plethora of different animal food products and corresponding production methods are known from the prior art. Conventionally, for example, a base composition is provided, which may be produced, for example, like a bread dough or cake mixture and may comprise any of a very wide variety of different ingredients. In the production of snacks or snack chews, especially for dogs or cats, in particular, the base composition thus produced is passed, for example, through an extruder and extruded into the desired shape. The cross-sectional shape of an animal food product of this kind is freely selectable. Other animal food products are available in the form, for example, of biscuits or similar units.

A drawback affecting all of these industrially producible animal food products, however, is that the animal food products thus produced look identical and so do not have the appearance of natural foods, especially meat. Since, however, dogs and cats are by nature meat-eaters, it is desirable to be able to produce animal food products which resemble at least the look of pieces of meat.

EP 1 094 791 B1 discloses a production method for foods that uses Mucorales fungi.

EP 0 505 412 B1 describes low-calorie meat products and methods for producing them.

U.S. Pat. No. 4,904,495 describes snack chews for dogs.

US 2003/0207006 A1 describes a method and a system for producing multiple products.

EP 1 223 817 B1 describes a method for producing encapsulated animal feeds, whereas US 2009/0311390 A1 describes dog treats and a method and also systems for the production thereof. None of these documents, however, describes individualized production of animal food products.

### DESCRIPTION OF THE INVENTION

The invention is therefore based on the object of specifying a method for producing animal food products wherein industrially produced animal food products have individual shapes.

The invention achieves the stated object by means of a method for producing an animal food product that has the following steps:

a) providing a base composition which preferably comprises gelatin,

b) forming a part of the base composition into a shape,

c) simmering or boiling the shape in a water bath;

in other words, the method is one for producing an animal food product, where the method has the following steps:
a) providing a base composition which preferably comprises gelatin,
b) forming a part of the base composition into an optionally unenveloped shape,
c) simmering or boiling the optionally unenveloped shape in a water bath for reshaping of the shape for individualized shaping,
d) optionally enveloping the reshaped shape from step c).

The simmering or boiling of animal foods has long been prior art. Conventionally, the base composition is produced from different ingredients, which must be stirred together with one another and optionally cooked. This is followed by the shaping or forming of the animal food by means, for example, of extruders.

There are a great many applications, moreover, in which animal foods are cooked after packing, in other words in the pack, which may be done, for example, in a heated water bath or using steam. The objective in that case is to heat the packaged animal food in such a way that it is sterilized and any microbes present are killed.

Foods of this kind, for example, including animal foods, such as sausages, etc., are pressed into a casing or skin before being heated, such as simmered or boiled, and then are processed within this casing or skin. Customarily, however, this produces no alteration to the texture of the food itself.

In contrast to this, in the case of a method in accordance with the invention, the base composition is provided. It may of course be freshly prepared and optionally cooked. How the base composition is obtained, however, is immaterial to the functioning of the present invention. In accordance with the invention, the shape composed of the base composition is simmered or boiled in the water bath before being packaged. The aim is not sterilization, which optionally may take place additionally in a later method step. For that purpose it is possible again to use the prior-art method of cooking and heating. In the case of the simmering or boiling of the shape in a water bath in accordance with method step c) of the method of the invention, however, this simmering or boiling takes place before the shape is packaged. The aim is to alter the external form of the shape in such a way that the shapes which have been produced in method step b) and which all look at least nearly identical, but preferably completely identical, is altered in such a way in step c) such that the individual shapes have individual forms.

When the base composition has been provided, parts of the base composition are formed into individual shapes. There are a host of different ways of accomplishing this. Thus, for example, it is possible to introduce the base composition into an extruder or similar device and to extrude the shapes. As an alternative to this, individual units, slices for example, can be cut off from base composition units, such as loaves. It is of course also possible to use other methods to form the shapes. The individual shapes, which may in particular be produced industrially, will look identical, owing to the identical mode of production of the individual shapes. There may at most be small deviations, resulting for example from uneven mixing of the individual constituents of the base composition and associated differences in elasticity in the base composition.

When the shapes have been formed, they are simmered or boiled in a hot water bath. Simmering is understood here to be the preparation of a food product or animal food product in a water bath with a temperature which is below the boiling temperature, being situated, for example at 80° C., 85° C., 90° C., or 95° C. The temperature of the water bath is advantageously at least 70° C., preferably at least 80° C., more preferably at least 90° C., but below the boiling temperature.

The temperature used is preferably high enough to cause the gelatin, which may be part of the base composition in one embodiment, to pass completely into solution. The gelatin becomes liquid and thickens the protein contained in the base composition. A network of gluten is formed, thereby bringing about the connection with the gelatin. Because of the ready formability in this condition, the method of the invention is accompanied by reshaping of the shape through the simmering or boiling of the shape in the water bath in accordance with method step c). Boiling refers to the preparation of the animal food products in a water bath with a temperature at or above the boiling temperature of water.

Additional additives may be admixed to the water bath used, possible examples being flavorings, colorants or other adjuvants. Particularly in the case where the base composition comprises gelatin, the base composition becomes plastically deformable as a result of the elevated temperature of the water bath. Particularly when using gelatin as a constituent of the base composition, moreover, a part of the water will be taken up by the base composition, so that the shape in this way changes its external form. Because this is dependent on a multiplicity of factors which can hardly be influenced, as for example the position of the shape in the water bath, the homogeneity of the mixture of the base composition, and, optionally, differences in contour and form brought about by the forming itself, each individual shape is in this way individualized in its geometric configuration. It has emerged that shapes treated in this way in accordance with step c) have entirely different shaping on leaving the water bath.

When the shapes have been simmered or boiled in the water bath, they are removed from the water bath and can be dried, for example, by means of a stream of air, which is optionally heated.

After the simmering or boiling, a structure is preferably introduced, more particularly embossed or stamped, into a surface, more particularly into a top face, of the shape. This is done preferably before the coating is applied. This structure may be used, for example, to imitate the imprints of a barbecue grid. A corresponding stamp or a corresponding embossing element may be printed onto the shaped part removed from the water bath, so that the structure remains in the surface of the shaped part. At this location the animal food product is preferably thereafter darker in color, and so visually as well the animal food product is approximated to a barbecued piece of meat. Of course, there are also other structures possible; for example, decorative elements, examples being company logos or names, may be introduced into the animal food product and subsequently emphasized in color as well by means of the colored coating.

Advantageously, after the simmering or boiling of the shapes but preferably before packing, a coating is applied which comprises at least a flavoring and a colorant. This has the effect on the one hand of approximating the visual appearance of the animal feed product to a natural product, and on the other hand of increasing acceptance by the animal through the use of one or more flavorings. If the shape, after the simmering or boiling in the water bath is initially to be dried, this is advantageously done before the application of the coating.

There are a host of different ways in which the coating can be applied. It is possible, for example, to apply the coating by spraying, to convey the shapes taken from the water bath through a corresponding coating operation, on a conveyor belt or conveyor grid, for example, or to dip or immerse the shapes into the coating.

The constituents of the coating may on the one hand influence and determine the color and the flavor of the animal food product produced. On the other hand, the coating may also serve, for example, as a protective coating against bacteria and may consequently improve the keeping qualities of the animal food product.

It has proven advantageous if the coated shape is dried, being preferably heated at a drying temperature for a drying time. Both the time and the temperature here are guided by the subsequent use of the animal food product. Hence it is possible, for example, for the animal food product to be designed as a snack chew. These animal food products have been available on the market for a long time and are designed in such a way that the animal has to keep chewing the product until it is eventually able to eat the animal food product. Through particular adjuvants in the animal food product it is possible in this way to bring about a tooth-cleansing function. If a relatively high drying temperature and/or a relatively long drying time are selected, the animal food product can be made crispier and may be used, for example, as a substitute for a pig's ear.

The drying temperature is preferably varied during the drying time. Drying takes place advantageously in a drying tunnel, through which the simmered or boiled, and coated, shapes for drying are passed. In this way it is possible with particular ease to vary the drying temperature in the course of the drying time, by heating different segments or sections of the drying tunnel at different temperatures. It is of course also possible by means of a corresponding arrangement, for example, to vary the rate of travel of the animal food products for drying through the individual sections of the drying tunnel and so, for example, to harmonize the residence time of the individual products within the individual tunnel segments to one another and so to adapt the drying time.

In one particularly preferred embodiment, smoke is added at least in sections in the drying tunnel. This gives the animal food product a smoky flavor, so making the imitation of the natural product for imitation more realistic and at the same time raising acceptance by the animal.

It is also possible, of course, to use other drying methods, as for example hot air drying or microwave drying.

Interestingly, as a result of the production method of the invention, a possibility for the end customer is to take the animal food product produced out of its packaging, into which it is packaged advantageously at the end of the method, and to subject it, for example, to further drying. This can be done by simply leaving the product lying after having removed it from the packaging, and not using it. As a result of this after-drying, the product changes in its chewing qualities, in particular, and becomes harder. It is possible in this way, for example, for a chewing product having a certain elasticity, to be able to be chewed by the animal for a certain period of time, to develop into a crackerlike or biscuitlike product which is used, for example, as a reward, without having to be chewed for a long time by the animal in question.

The forming of the shapes is accomplished advantageously by cutting off or tearing off a piece from the base composition. Other embodiments are of course also possible. In the case of tearing off, in particular, the external contour and the form of the shape are easily individualized in this early step, because tearing does not take place in a completely reproducible way, but is instead likewise dependent on a host of different parameters, which are difficult, if not impossible, to monitor or control.

In a further embodiment of the method of the invention, the shape for treatment in step c) is more particularly not present in a casing or skin, and more particularly is not a sausage or sausagelike product present in a casing or skin.

In a further embodiment of the present method, a multiplicity of shapes are simmered or boiled in the water bath simultaneously in step c), more particularly such that they are in contact with one another during the boiling or simmering.

One embodiment, lastly, relates to a method of the invention in which in step b) the shapes are formed in the form of slices.

In accordance with the invention, the proportion of meat in the base composition can be low; for example, in the base composition and also in the subsequent animal food product, the meat content is at most 10% by weight, such as at most 8% by weight, e.g., at most 5% by weight, such as at most 4% by weight. The meat content may optionally be replaced by a meat substitute content.

The fat content in the base composition and in the animal food product is likewise low, e.g., at most 10% by weight, such as at most 8% by weight, e.g., at most 5% by weight, such as at most 4% by weight.

The invention achieves the stated object, moreover, by means of an animal food product which is producible or produced by a method of the type described here. The base composition of this animal food product advantageously comprises gelatin.

In one embodiment, the animal food product here is a dried, keepable, and packaged product. A keepable product is one which can be stored over a prolonged period of time at ambient temperature, such as room temperature. The product here is dried; in other words, after shaping, the product has been subjected to drying before being packed. In one embodiment the animal food product is a snack chew which allows long-term chewing. In another embodiment, the product is a dried animal food product, in the form, for example, of biscuits or other dog treats or animal treats.

As stated, the animal food product here may exhibit a meat content of at most 10% by weight, such as at most 8% by weight, e.g., at most 5% by weight, such as at most 4% by weight.

The animal food products of the invention are customarily packaged individually.

In one embodiment, the packaging for packing in accordance with the method of the invention, or as packaging of the animal food product of the invention, is an inedible packaging. In one embodiment, the packaging here is airtight packaging.

In a method of the invention, the shapes are simmered or boiled in the water bath. In that case, the respective shape initially sinks downward, its density being greater than that of the surrounding water. In the course of the simmering or boiling, however, there is a reduction in the density of the shape, and so it rises upward in the water bath. Consequently, as soon as the shape is floating on the water surface, it can be removed. Removal at any earlier point in time is of course also possible.

In this procedure, the shapes customarily take up water from the water bath.

The individual shaping brought about in particular by the water taken up, but also by other effects, can be boosted if the water bath is boiling and if bubbles are rising. These bubbles produce turbulences in the water bath that ensure that mechanical impacts between the shapes present in the water bath, and also impacts between a shape and the wall of the water bath, occur, and these impacts influence the form and outer contour of the shape.

The coating is applied advantageously with a pre-prepared mixture of various additives and ingredients. In one particularly preferred embodiment, there is also a part of this mixture within the base composition, which therefore contains, in particular, the flavoring, so increasing acceptance by the animal.

Instead of the gelatin described here, it is of course also possible to use a different product—a plant product, for example. A feature of these products is that they contribute to a change in the texture of the base composition during the simmering or boiling. This change in texture is customarily one which makes the base composition more plastic or tougher. The base composition, which may be present in the form of a dough, generally has a certain toughness, allowing a so-called “retreat” to take place, for example, when a part is cut off in order to form the shape. This means that the cut edge formed is not a clean edge each time, and so fraying and small projecting parts of each shape may be present.

By means of the methods described here, it is possible to produce snack chews or else products in the form of chips. The distinction as to what kind of products are to be produced is made preferably by way of the drying time and the drying temperature.

An exemplary embodiment of the present invention is elucidated in more detail below by means of the appended drawing, in which

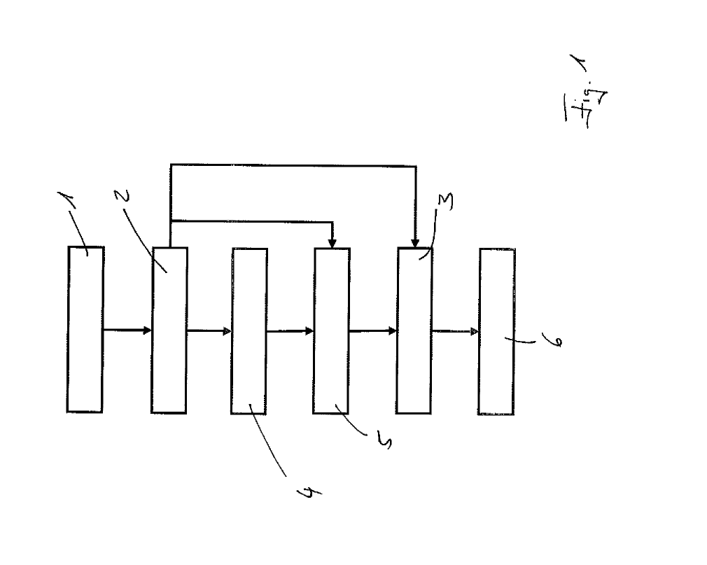

FIG. 1 shows the schematic representation of a course of a method in accordance with a first exemplary embodiment of the present invention.

In the first step of the method, a base composition is provided 1, from which the animal food product is to be produced. This base composition may be provided in any of a very wide variety of different ways. It is preferably prepared freshly from various ingredients, in the form of a dough, for example, and provided in this way to the method. As an alternative to this, it may also have been pre-prepared, and may only need to be removed, optionally, from a pack.

This is followed by the shaping 2 of at least part of the base composition to form a shape. In this case, parts can be cut off or otherwise formed from the base composition produced, which preferably comprises gelatin. In one embodiment of the method that is particularly easy and quick to perform, the shape thus produced is supplied in the method step of simmering or boiling 3. This occurs in a water bath, with the external form of the shape changing differently, individually, for each shape. The simmering or boiling 3 takes place in particular before the completed product is packed—which is not shown in FIG. 1. The shape, accordingly, comes directly into contact with the water bath.

In a somewhat more involved embodiment of the method, the formed shape from the forming 2 step is subjected initially to embossing 4, in the course of which a structure is introduced into a surface of the shape. The shape thus provided with a structure then goes to coating 5, by application of a coating. At the end of the method, the drying 6 takes place.

### LIST OF REFERENCE NUMERALS

1 Providing
2 Forming
3 Simmering or boiling
4 Embossing
5 Coating
6 Drying

1. A method for producing an animal food product, comprising:
a) providing a base composition,
b) forming a part of the base composition into an optionally unenveloped shape,
c) simmering or boiling the optionally unenveloped shape in a water bath for reshaping of the shape for individualized shaping and production of a reshaped shape, and
d) optionally enveloping the reshaped shape from step c).

2. The method as claimed in claim 1, further comprising introducing a structure into a surface of the shape after the simmering or boiling of step c).

3. The method as claimed in claim 1, further comprising applying a coating which comprises at least a flavoring and a colorant to the reshaped shape.

4. The method as claimed in claim 3, further comprising drying the coating.

5. The method as claimed in claim 16, wherein the drying temperature is varied during the drying time.

6. The method as claimed in claim 4, wherein the drying takes place in a drying tunnel.

7. The method as claimed in claim 6, further comprising adding smoke at least in sections in the drying tunnel.

8. The method as claimed in claim 1 wherein the shape is formed by cutting off or tearing off a piece from the base composition.

9. The method as claimed in claim 1 wherein the composition is not present in a casing or skin at least during step c).

10. The method as claimed in claim 1 wherein step c) is performed with a plurality of optionally unenveloped shapes together in the water bath wherein the plurality of shapes are in contact with one another during the boiling or simmering.

11. The method as claimed in claim 1 wherein forming in step b) produces shapes in slice form.

12. An animal food product produced by a method as claimed in claim 1.

13. The animal food product as claimed in claim 12, wherein the base composition comprises gelatin.

14. The animal food product as claimed in claim 12 wherein the animal food product is a dried, keepable, and packaged product.

15. The animal food product as claimed in claim 12 wherein the base composition has a meat content of at most 10% by weight.

16. The method as claimed in claim 4 wherein the drying is performed by heating a drying temperature for a drying time.

17. The method as claimed in claim 1 wherein the base composition comprises gelatin.

18. The method as claimed in claim 2 wherein the step of introducing is performed by embossing or stamping.

19. The method as claimed in claim 1 wherein enveloping the reshaped shape from step c) is performed in step d).

20. The animal food product as claimed in claim 12 configured as a snack chew.
